(19) United States
(12) Patent Application Publication
(10) Pub. No.: US 2006/0100997 A1
(43) Pub. Date: May 11, 2006

(54) Data caching

(76) Inventors: Gary C. Wall, Allen, TX (US); Ryan Edward Enge, Dallas, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/974,653

(22) Filed: Oct. 27, 2004

(51) Int. Cl. G06F 17/30

(52) U.S. Cl. 707/3

(57) ABSTRACT

One exemplary data caching architecture having a data cache operable on one or more of cooperating components of a computing environment to store and retrieve computing environment data is provided. The data cache cooperates with the computing environment components to request computing environment data based on selected conditions and store the data for future use by the computing environment. The architecture further has a data cache logic module providing at least one instruction to the data cache to store, retrieve, and process data.

### BACKGROUND

The time required to process data transactions (e.g. processing speed and efficiency) is a benchmark for a computing environment's operational effectiveness. Computing environment operators seek to maximize the operating performance of the computing environment to reduce possible latencies when processing data. There are a number of approaches that have been taken to optimize performance that include but are not limited to, modifying the computing environment's configuration variables, development and implementation of software-based data processing acceleration applications and solutions, and changing the physical hardware components and/or configuration.

In the context of large scale computing environments, having numerous cooperating computing components (e.g., computer servers, client computers, peripherals, etc.), processing latency can propagate across one or more of the cooperating computing components as data is being processed. Although the latency produced by an individual computing component may be trivial, such latency can aggregate and multiply as additional computing environment components are utilized during a data processing transaction.

For example, in a distributed computing environment having a large number of computing components (e.g., a server farm), the processing of operational data (e.g., system event logs) can be resource intensive and impact the performance of the computing environment. Operational data may take on various forms and contain various information about the computing environment. Such data assists computing environment operators to identify non-functioning or malfunctioning components of the computing environment on a diagnostic basis. In addition, computing environment operators can use operational data to establish operational metrics for the computing environment.

Computing environments can be generally configured to generate and store operational data on a periodic basis. With conventional practices, each of the cooperating components of the computing environment (e.g., computer servers) are simultaneously polled by a computing environment management application (e.g., computing environment monitor) to generate and communicate operational data. As each of the cooperating computing environments respond to the computing environment management application, each component expends valuable processing resources to generate and communicate its operational data. In a computing environment having a number of cooperating components, processing latency results and persists across the entire computing environment when operational data is being requested, generated, and processed. Such latency can impact the operational performance of the computing environment.

### BRIEF DESCRIPTION OF THE DRAWINGS

The data caching architecture and methods of use are further described with reference to the accompanying drawings in which:

FIG. 1 is a block diagram of an exemplary computing environment in accordance with an implementation of the herein described systems and methods;

FIG. 2 is a block diagram showing the cooperation of exemplary components of an exemplary data communications architecture;

FIG. 3 is a block diagram of an exemplary computing environment having an exemplary implementation of the herein described systems and methods;

FIG. 4 is a block diagram of a an exemplary data communication architecture utilizing caching;

FIG. 5 is a block diagram of another exemplary data communication architecture utilizing caching;

FIG. 6 is a block diagram of another exemplary data communication architecture utilizing caching; and

FIG. 7 is a flow chart diagram of the processing performed when handling data caching in accordance with an implementation of the herein described systems and methods.

### DETAILED DESCRIPTION

Overview:

Operational efficiency and optimization are metrics used to rate the performance of a computing environment. In this context, computing environments can be configured to poll the components of the computing environment to identify if the cooperating computing environment components are operating properly and efficiently. The computing environment can be further configured such that the cooperating computing environment components cooperate with each other to create and communicate operational data back to the computing environment. The cooperating computing environment components in processing operational data can expend computing environment resources contributing to computing environment processing latencies. Although such latencies may not be significant for computing environments having a few cooperating components, these latencies can substantially impact the overall performance of a computing environment having numerous cooperating components.

Conventional practices rely on computing environment configuration to combat persisting processing latencies. For example, a computing environment can be configured to request operational data from cooperating computing environment components during observed and identified time periods where there is low processing. Additionally, computing environment operators may combat such latencies by adding additional computing environment components to handle the additional processing load resulting from the creation and communication of operational data between the computing environment components. Such practices can be arduous, impracticable, and costly. Specifically, if a computing environment is configured to only provide operational data in low processing times, computing environment operators stand in the position of not having a real-time snapshot of the computing environment and are not able to detect underperforming or non-performing computing environment components on a continual, uninterrupted basis. Additionally, by assigning more computing environment components to address processing latencies, computing environment operators are placed in the position of having to expend limited budgets for such components that may not be available.

The herein described systems and methods aim to ameliorate the shortcomings of existing practices by providing a data caching architecture that employs a data cache for use when processing computing environment data, including but not limited to, computing environment operational data. In an illustrative implementation, the data caching architecture comprises a data cache and data cache logic module operating on one or more components of the computing environment components. The data cache logic module can contain one or more instructions sets to direct the data cache to retrieve, store, and communicate data between cooperating components of the computing environment.

In the implementation provided, the exemplary computing environment can have a first processor (e.g., management processor) having a data store for use in creating and storing computing environment data (e.g., operational data). The computing environment can further have a second processor (e.g., intermediate processor) that cooperates with the first processor to retrieve created and/or stored computing environment data. The second processor can further cooperate with a data cache to store data retrieved from the first processor for subsequent processing and/or communication one or more cooperating components of the computing environment. In an illustrative implementation, the one or more cooperating components of the computing environment can include but is not limited to a data agent which can operate within the computing environment to field requests for data by the computing environment.

In such implementation, the illustrative data caching architecture system and methods described herein can operate in such a manner wherein the data agent receives a request from the computing environment for specific computing environment data. The data agent can cooperate with the second processor, which in turn cooperates with the data cache, to determine if the requested data is stored in the data cache. If the data is stored in the data cache, the data agent cooperates with the data cache to obtain the requested data and delivers the requested data to the computing environment. However, if the requested data is not in the data cache, the data cache, cooperating with the second processor, sends a request to the first processor and associated first processor data store to send a block of data. The data cache stores the block of data received from the first processor and associated first processor data store. The data cache, operating under the direction of a data cache logic module, determines if the requested data is within the retrieved data block. If it is not, an additional request is sent to the first processor and the associated first processor data store for more data blocks. However, if the requested data is determined to be in the data cache, the requested data (i.e., requested by the computing environment) is sent to the data agent for communication to the computing environment. In the event that the requested data is neither present in the first processor or associated first processor data store or the data cache, the data agent returns an indication to the computing environment that the requested data is not available from the cooperating first or second processors.

In the context of processing computing environment operational data, the herein described systems and methods can operate to process system event log data on an intelligent platform management interface (IPMI) block transfer (BT) computing environment. The herein described IPMI BT computing environment can be based on the INTEL® IPMI standard (e.g., IPMI Specification V 2.0 which is herein incorporated by reference in its entirety). In IPMI computing environments, the computing environment hardware components (e.g., baseboard, chassis, fan, etc.) can cooperate with a management software module to create and store operational data about the computing environment components (e.g., temperature, voltage, throughput, etc.) that may be used by computing environment operators to identify underperforming, non-performing, or malfunctioning computing environment components. The IPMI architecture allows for efficient and straightforward interoperability between heterogeneous computing environment components (e.g., heterogeneous computer servers) to create and store computing environment operational data. Additionally, the IPMI architecture allows for scalability as additional components (e.g., homogenous and/or heterogeneous) can be added to the computing environment for which operational data can be created and stored.

Illustrative Computing Environment

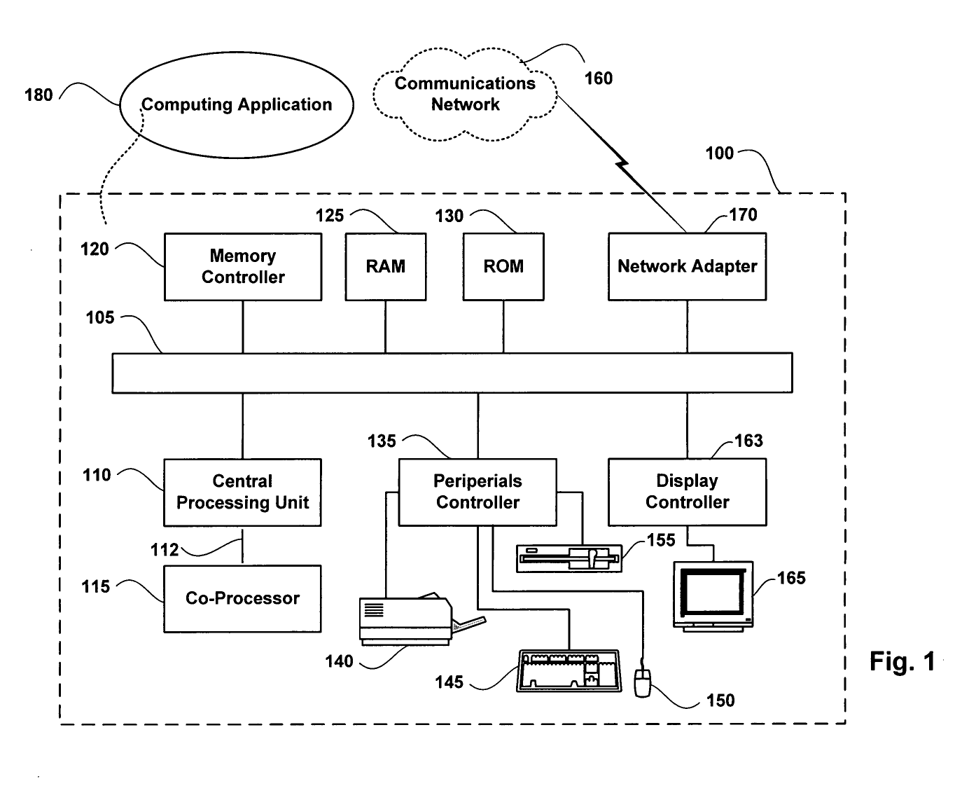

FIG. 1 depicts an exemplary computing system 100 in accordance with herein described system and methods. The computing system 100 is capable of executing a variety of computing applications 180. Exemplary computing system 100 is controlled primarily by computer readable instructions, which may be in the form of software. The computer readable instructions can contain instructions for computing system 100 for storing and accessing the computer readable instructions themselves. Such software may be executed within central processing unit (CPU) 110 to cause the computing system 100 to do work. In many known computer servers, workstations and personal computers CPU 110 is implemented by micro-electronic chips CPUs called microprocessors. A coprocessor 115 is an optional processor, distinct from the main CPU 110, that performs additional functions or assists the CPU 110. The CPU 110 may be connected to co-processor 115 through interconnect 112. One common type of coprocessor is the floating-point coprocessor, also called a numeric or math coprocessor, which is designed to perform numeric calculations faster and better than the general-purpose CPU 110.

It is appreciated that although an illustrative computing environment is shown to comprise the single CPU 110 that such description is merely illustrative as computing environment 100 may comprise a number of CPUs 110. Additionally computing environment 100 may exploit the resources of remote CPUs (not shown) through communications network 160 or some other data communications means (not shown).

In operation, the CPU 110 fetches, decodes, and executes instructions, and transfers information to and from other resources via the computer's main data-transfer path, system bus 105. Such a system bus connects the components in the computing system 100 and defines the medium for data exchange. The system bus 105 typically includes data lines for sending data, address lines for sending addresses, and control lines for sending interrupts and for operating the system bus. An example of such a system bus is the PCI (Peripheral Component Interconnect) bus. Some of today's advanced busses provide a function called bus arbitration that regulates access to the bus by extension cards, controllers, and CPU 110. Devices that attach to these busses and arbitrate to take over the bus are called bus masters. Bus master support also allows multiprocessor configurations of the busses to be created by the addition of bus master adapters containing a processor and its support chips.

Memory devices coupled to the system bus 105 include random access memory (RAM) 125 and read only memory (ROM) 130. Such memories include circuitry that allows information to be stored and retrieved. The ROMs 130 generally contain stored data that cannot be modified. Data stored in the RAM 125 can be read or changed by CPU 110 or other hardware devices. Access to the RAM 125 and/or ROM 130 may be controlled by memory controller 120. The memory controller 120 may provide an address translation function that translates virtual addresses into physical addresses as instructions are executed. Memory controller 120 may also provide a memory protection function that isolates processes within the system and isolates system processes from user processes. Thus, a program running in user mode can normally access only memory mapped by its own process virtual address space; it cannot access memory within another process's virtual address space unless memory sharing between the processes has been set up.

In addition, the computing system 100 may contain peripherals controller 135 responsible for communicating instructions from the CPU 110 to peripherals, such as, printer 140, keyboard 145, mouse 150, and data storage drive 155.

Display 165, which is controlled by a display controller 163, is used to display visual output generated by the computing system 100. Such visual output may include text, graphics, animated graphics, and video. The display 165 may be implemented with a CRT-based video display, an LCD-based flat-panel display, gas plasma-based flat-panel display, a touch-panel, or other display forms. The display controller 163 includes electronic components required to generate a video signal that is sent to display 165.

Further, the computing system 100 may contain network adaptor 170 which may be used to connect the computing system 100 to an external communication network 160. The communications network 160 may provide computer users with connections for communicating and transferring software and information electronically. Additionally, communications network 160 may provide distributed processing, which involves several computers and the sharing of workloads or cooperative efforts in performing a task. It will be appreciated that the network connections shown are exemplary and other means of establishing a communications link between the computers may be used.

It is appreciated that the exemplary computer system 100 is merely illustrative of a computing environment in which the herein described systems and methods may operate and does not limit the implementation of the herein described systems and methods in computing environments having differing components and configurations as the inventive concepts described herein may be implemented in various computing environments having various components and configurations.

Illustrative Computer Network Environment:

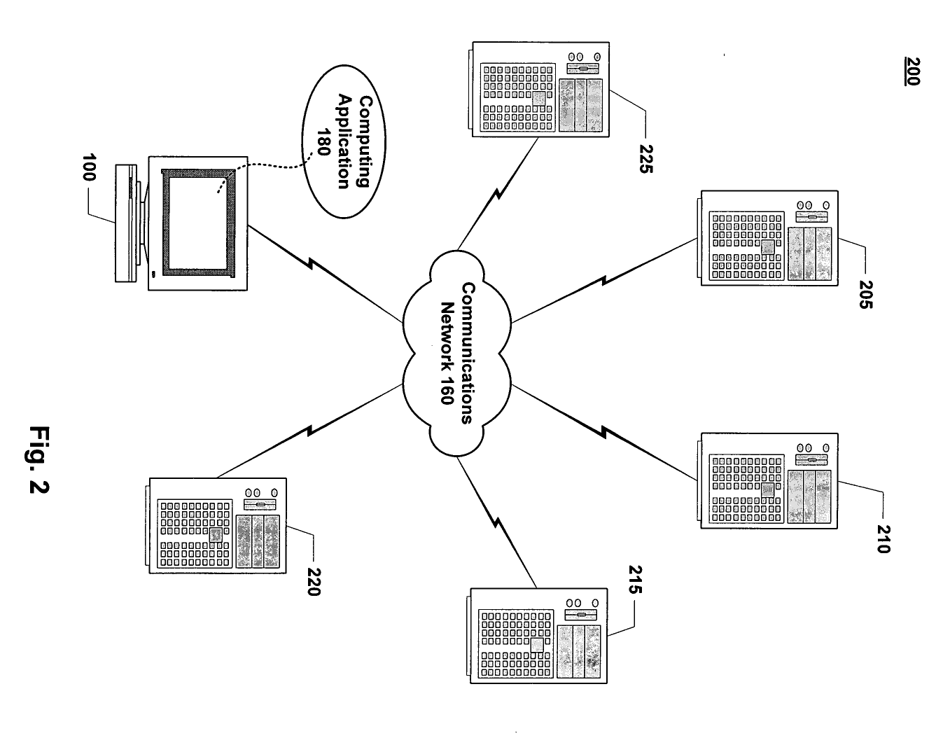

The computing system 100, described above, can be deployed as part of a computer network. In general, the above description for computing environments applies to both server computers (e.g., server computing environments) and client computers (client computing environments) deployed in a network environment. FIG. 2 illustrates an exemplary illustrative networked computing environment 200, with a server in communication with client computers via a communications network, in which the herein described apparatus and methods may be employed. As shown in FIG. 2 servers 205, 210, 215, 220, and 225 may be interconnected via a communications network 160 (which may be either of, or a combination of a fixed-wire or wireless LAN, WAN, intranet, extranet, peer-to-peer network, the Internet, or other communications network) with one or more client computing environments, such as, the client computer 100 executing computing application 180. Additionally, the herein described system and methods may cooperate with automotive computing environments (not shown), consumer electronic computing environments (not shown), and building automated control computing environments (not shown) via the communications network 160. In a network environment in which the communications network 160 is the Internet, for example, servers 205, 210, 215, 220, and 225 can be dedicated computing environment servers operable to process and communicate computing environment data to and from client computing environments 100 via any of a number of known protocols, such as, hypertext transfer protocol (HTTP), file transfer protocol (FTP), simple object access protocol (SOAP), or wireless application protocol (WAP). Client computing environment 100 can be equipped with computing application 180 (e.g., web browser computing application) operable to support one or more features and operations such as content viewing and navigation.

In operation, a user (not shown) may interact with a computing application running on a client computing environments to obtain desired data and/or computing applications. The data and/or computing applications may be stored on server computing environments 205, 210, 215, 220, and 225 and communicated to cooperating a operator through client computing environment 100 over exemplary communications network 160. A participating user may request access to specific data and applications housed in whole or in part on server computing environments 205, 210, 215, 220, and 225. These data transactions may be communicated between client computing environment 100 and server computing environments 205, 210, 215, 220, and 225 for processing and storage. Server computing environments 205, 210, 215, 220, and 225 may host computing applications, processes and applets (not shown) for the generation, authentication, encryption, and communication of data and may cooperate with other server computing environments (not shown), third party service providers (not shown), network attached storage (NAS) and storage area networks (SAN) to realize such web services transactions.

Thus, the systems and methods described herein can be utilized in a computer network environment having client computing environments for accessing and interacting with the network and server computing environments for interacting with client computing environment. However, the apparatus and methods providing the data caching architecture can be implemented with a variety of network-based architectures, and thus should not be limited to the example shown. The herein described systems and methods will now be described in more detail with reference to a presently illustrative implementation.

Data Caching Architecture:

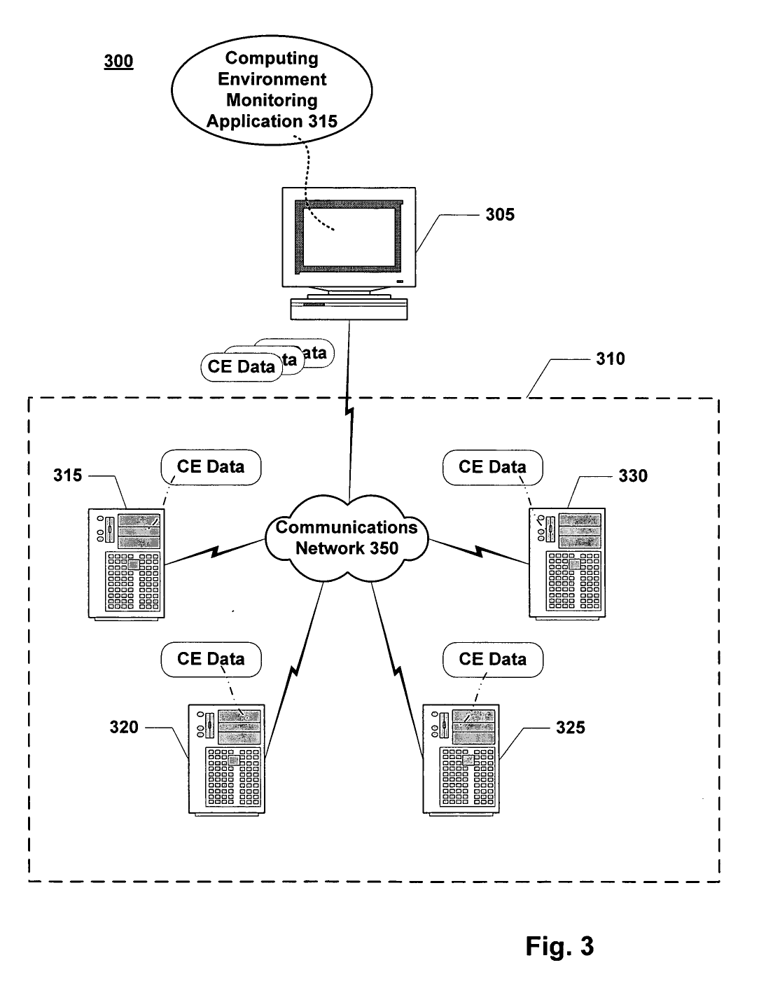

FIG. 3 shows a block diagram of an exemplary computing environment operating in a manner to collect computing environment data as part of computing environment maintenance and management operations. As is shown, exemplary computing environment 300 comprises computer 305 operating computing environment monitoring application 315. Computer environment 300 computer 315 cooperates with networked computers 315, 320, 325, and 330 over communications network 350. In operation, computing environment monitoring application 315 operating on computer 305 can cooperate with one or more of networked computers 315, 320, 325, and 330 to obtain computing environment data (CE data) for processing. As part of its processing, computing environment monitoring application 315 can aggregate, categorize, and format the computing environment data as part of processing and/or reporting operations (not shown). The computing environment data can include, but is not limited to, various information about the operation of the computing environment 300, networked computers 315, 320, 325, and 330, and computing environment event information (not shown).

It is appreciated that although exemplary computing environment 300 is shown to have a plurality of computers and a computing application, that such description is merely illustrative as the inventive concepts described herein can be applied to a computing environment having various computers and computing applications (e.g., a single computer and multiple computing applications).

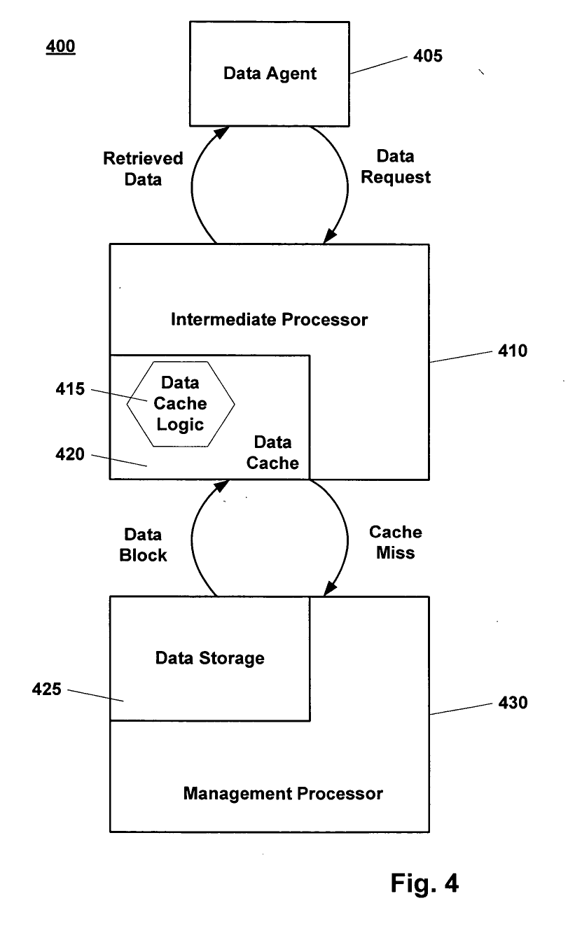

FIG. 4 shows a block diagram of an exemplary data caching architecture 400. As is shown, data caching architecture 400 comprises data agent 405, intermediate processor 410, data cache logic module 415, data cache 420, data storage 425, and management processor 430. In operation, data agent 405 may field requests for data (e.g., operational data) from a computing environment (not shown). Data agent 405 can cooperate with intermediate processor 410 to determine if intermediate processor 410 has the desired data requested by exemplary computing environment (not shown). Intermediate processor 410 can cooperate with data cache 420 operating under instructions from data cache logic module 415. Data cache logic module 415 provides instructions to data cache 420 to store and retrieve data to satisfy requests provided by data agent 405 and to communicate with management processor 430 to retrieve data from data storage 425 of management processor 430.

In the context of processing computing environment operational data, exemplary data caching architecture 400 can operate in the following manner. A computing environment (See FIG. 3 exemplary computer 300) can provide a request for operational data to data agent 405. In turn, data agent 405 cooperates with intermediate processor 410 to find the requested operational data. Intermediate processor 410 can then cooperate with data cache 420 operating under the direction of data cache logic 415 to determine if the requested operational data is located in data cache 420. If the requested data is located within data cache 420, the requested operational data is returned to data agent 405, which in turn, returns it to data agent 405. However, if the requested operational data is not located within data cache 420, data cache 420 cooperates with management processor 430 to request a data block from data storage 425. The data block is received by data cache 420 and stored in the data cache 420. Another check is made for the requested operational data. If the requested operational data is now located within data cache 420, data cache 420 returns the requested operational data to data agent 405.

Furthermore, with reference to an exemplary implementation in accordance with the IPMI specification, the management processor 430 of FIG. 4 can be a management processor operating a virtualized baseboard management controller (BMC). Furthermore, intermediate processor 410 can be a processor dependent hardware controller (PDHC) having a management processor interface and a IPMI BT hardware interface. Additionally, data agent 405 can be block transfer hardware that cooperates with an exemplary operating system that operates a IPMI BT driver. In such an IPMI data communications architecture, the management processor can cooperate with the PDHC through a virtualized BMC and an MP interface operating on the PDHC. In turn the PDHC can cooperate with the BT hardware through IPMI BT hardware interface. Lastly, BT hardware can cooperate with the operating system through the IPMI BT driver executing on the operating system.

It is appreciated that although exemplary data caching architecture 400 is shown to have particular components in a particular configuration that such description is merely illustrative as the inventive concepts described herein are applicable to a data caching architecture having the same or different components arranged in various configurations. For example, exemplary data caching architecture 400 can have a plurality of IPMI BT registers controllable by the management processor 430 and the computing environment (not shown) in place of intermediate processor 410.

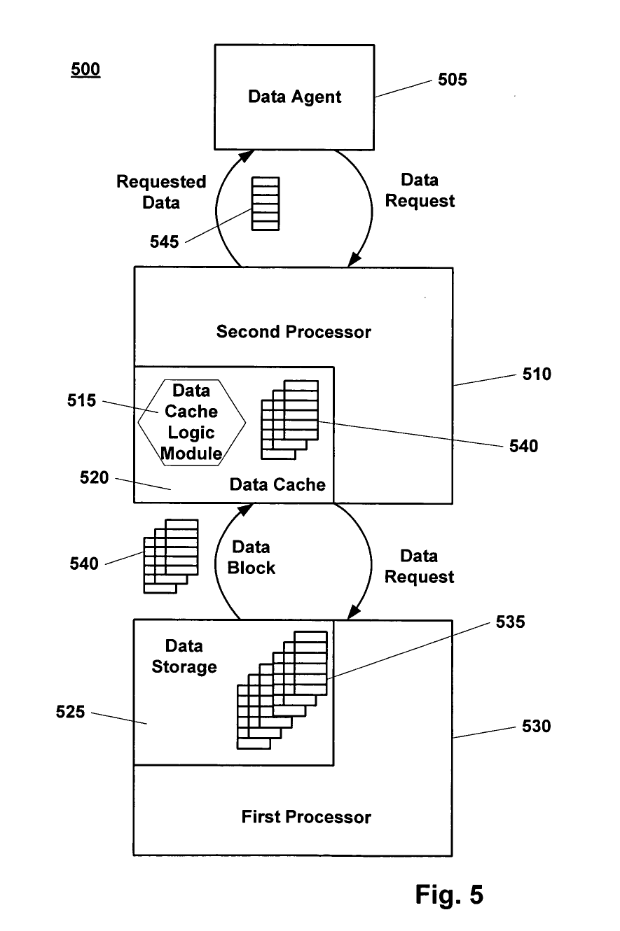

FIG. 5 shows a block diagram of another exemplary data caching architecture 500. As is shown, data caching architecture 500 comprises data agent 505, second processor 510, data cache logic module 515, data cache 520, data storage 525, and first processor 530. In operation, data agent 505 may field requests for data (e.g., operational data) from a computing environment (not shown). Data agent 505 can cooperate with second processor 510 to determine if second processor 510 has the desired data 535 requested by exemplary computing environment (not shown). Second processor 510 can cooperate with data cache 520 operating under instructions from data cache logic module 515. Data cache logic module 515 provides instructions to data cache 520 to store and retrieve data 535 to satisfy requests provided by data agent 505 and to communicate with first processor 530 to retrieve data blocks 535 from data storage 525 of first processor 530.

In the context of processing computing environment operational data, exemplary data caching architecture 500 can operate in the following manner. A computing environment (not shown) can provide a request for operational data to data agent 505. In turn, data agent 505 cooperates with second processor 510 to find the requested operational data 535. Second processor 510 can then cooperate with data cache 520 operating under the direction of data cache logic 515 to determine if the requested operational data 545 is located in data cache 520. If the requested data 545 is located within data cache 520, the requested operational data 545 is returned to data agent 505, which in turn, returns it to data agent 505. However, if the requested operational data 545 is not located within data cache 520, data cache 520 cooperates with first processor 530 to request a large data block 540 from data storage 525. In operation, data storage 525 of first processor 530 can store comprehensive data block 535 from which large data block 540 is prepared for communication to data cache 520. The large data block 540 is received by data cache 520 and stored in the data cache 520. Another check is made for the requested operational data 545. If the requested operational data 545 is now located within data cache 520, data cache 520 returns the requested operational data 545 to data agent 505.

It is appreciated that requested data 545 is smaller in size than large data block 540 which itself is smaller in size than comprehensive data block 535. It is further appreciated that the herein described systems and methods ameliorate the shortcomings of existing practices by transferring computing environment operational data between cooperating computing environment components in large data blocks which can be stored in a operable data cache operating on one or more of such cooperating computing environment components. The data cache, responsive, to one or more instructions found in an exemplary data cache logic module can cooperate with one or more cooperating computing environment components to retrieve and deliver smaller blocks of computing environment operational data. As such the data cache allows computing environment operators to obtain desired computing environment operational data more quickly and more efficiently. As well, valuable computing environment processing resources are not wasted in polling each of the cooperating computing environment components to retrieve such computing environment operational data on a per request basis. Rather, computing resources can be managed and selected to poll the exemplary data cache for required computing environment operational data. Moreover, the computing environment resources required to place the computing environment operational data in the data cache can be selected to operate during time periods in which there is an abundance of computing environment resources (e.g., in the middle of the night).

Furthermore, with reference to an exemplary implementation in accordance with the IPMI specification, first processor 530 of FIG. 5 can be a manageability processor operating a virtualized baseboard management controller (BMC). Furthermore, second processor 510 can be a processor dependent hardware controller (PDHC) having a manageability processor interface and a IMPI BT hardware interface. Additionally, data agent 505 can be block transfer hardware that cooperates with an exemplary operating system that operates a IPMI BT driver. In such IPMI data communications architecture, the manageability processor can cooperate with the PDHC through virtualized BMC and an MP interface operating on the PDHC. In turn the PDHC can cooperate with the BT hardware through IPMI BT hardware interface. Lastly, BT hardware can cooperate with the operating system through the IPMI BT driver executing on the operating system.

It is appreciated that although exemplary data caching architecture 500 is shown to have particular components in a particular configuration that such description is merely illustrative as the inventive concepts described herein are applicable to a data caching architecture having the same ore different components arranged in various configurations. For example, exemplary data caching architecture 500 can have a plurality of IPMI BT registers controllable by the management processor 530 and the computing environment (not shown) in place of intermediate processor 510.

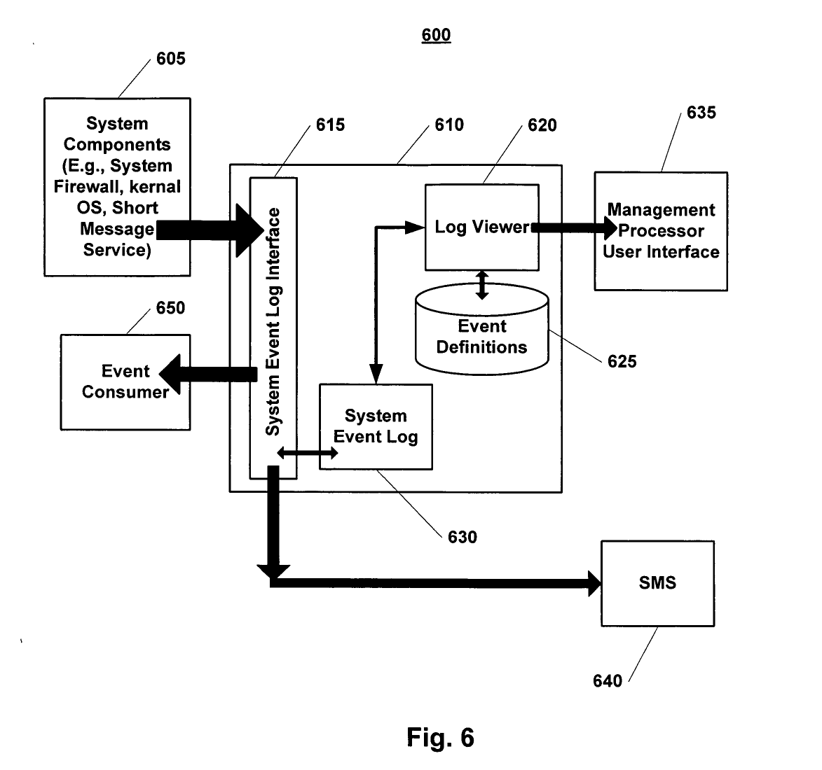

FIG. 6 shows a block diagram of another exemplary data communication architecture in accordance with the herein described systems and methods. As is shown in FIG. 6, data communication architecture 600 comprises exemplary monitoring module 610, system components 605, event consumer 650, short message service (SMS) 640, and management processor user interface 635. Further, as is shown in FIG. 6, exemplary monitoring module 610 comprises system event log interface 615, system event log 630, event definitions 625, and log viewer 620.

In operation, system components 605 provide event information to system event log definitions 615 for storage in system event log 630. The system event log 630 (which can comprise one or more data caches) can cooperated with log viewer 620. In turn, log viewer 620 can cooperate with management processor user interface 635 to provide event information for display and manipulation on management processor user interface 635. Additionally, log viewer 620 cooperates with event definitions data store 625 that provide at least one instruction (not shown) to log viewer 635 to process and display event information. Also, as is shown in FIG. 6, system event log 630 can cooperate with system event log interface 615 to provide event information to event consumer 650. Additionally, system event log interface can act to communicate system event information to SMS 640. SMS 640 can operate to communicate system event information (not shown) to cooperating components (not shown) using an exemplary SMS communications protocol (not shown).

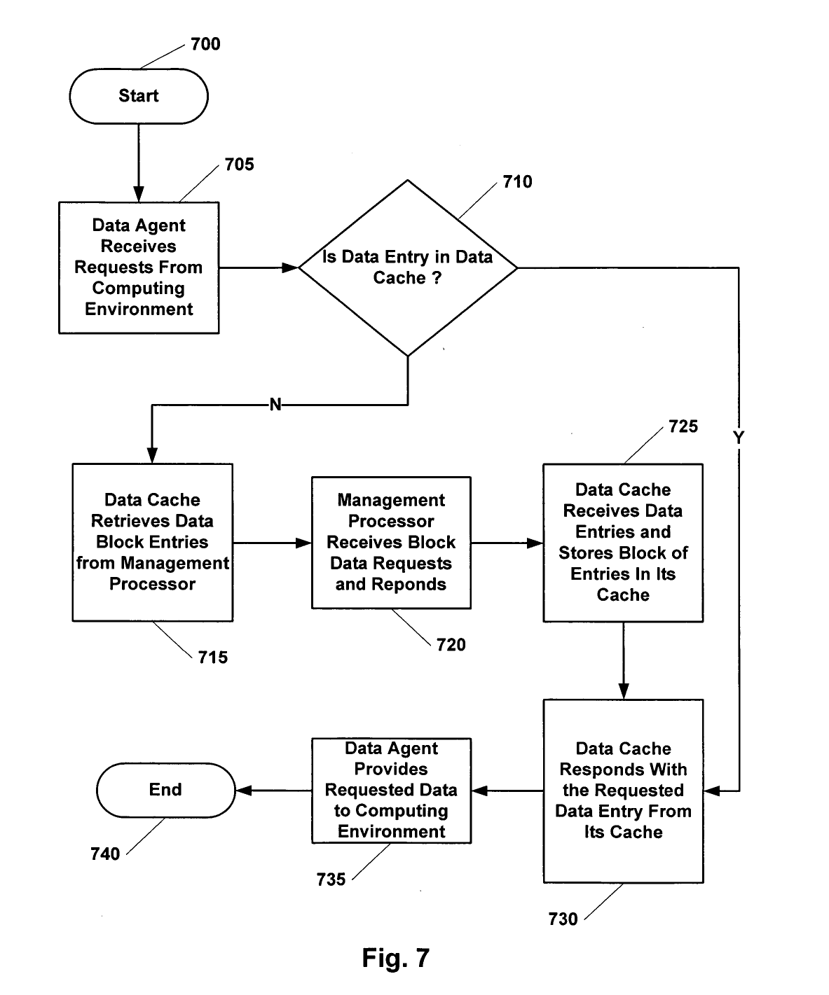

FIG. 7 shows the processing performed by the data caching system and methods described herein when handling data for the exemplary computing environment. As is shown, processing begins at block 700 and proceeds to block 705 where a data agent receives a request for data by the computing environment. A check is then performed at block 710 to determine if the requested data resides in a data cache. If the check at block 710 indicates that data is not present in the data cache, processing proceeds to block 715 where the data cache requests a block of data from a cooperating management processor. From there processing proceeds to block 720 where the management processor receives the block data requests and responds to the data cache. Processing then proceeds to block 725 where the data cache stores the retrieved requested data from the management processor. The data cache then passes the retrieved stored requested data retrieved from the management processor (430 of FIG. 4) to the data agent at block 730. The data agent passes along the requested data to the computing environment for subsequent processing by the computing environment. At block 740 processing terminates.

However if at block 710 the check indicates that the requested data is in the data cache, processing proceeds to block 730 and continues from there.

It is understood that the herein described systems and methods are susceptible to various modifications and alternative constructions. There is no intention to limit the invention to the specific constructions described herein. On the contrary, the invention is intended to cover all modifications, alternative constructions, and equivalents falling within the scope and spirit of the invention.

It should also be noted that the present invention may be implemented in a variety of computer environments (including both non-wireless and wireless computer environments), partial computing environments, and real world environments. The various techniques described herein may be implemented in hardware or software, or a combination of both. Preferably, the techniques are implemented in computing environments maintaining programmable computers that include a processor, a storage medium readable by the processor (including volatile and non-volatile memory and/or storage elements), at least one input device, and at least one output device. Computing hardware logic cooperating with various instructions sets are applied to data to perform the functions described above and to generate output information. The output information is applied to one or more output devices. Programs used by the exemplary computing hardware may be preferably implemented in various programming languages, including high level procedural or object oriented programming language to communicate with a computer system. Illustratively the herein described apparatus and methods may be implemented in assembly or machine language, if desired. In any case, the language may be a compiled or interpreted language. Each such computer program is preferably stored on a storage medium or device (e.g., ROM or magnetic disk) that is readable by a general or special purpose programmable computer for configuring and operating the computer when the storage medium or device is read by the computer to perform the procedures described above. The apparatus may also be considered to be implemented as a computer-readable storage medium, configured with a computer program, where the storage medium so configured causes a computer to operate in a specific and predefined manner.

Although an exemplary implementation of the invention has been described in detail above, those skilled in the art will readily appreciate that many additional modifications are possible in the exemplary embodiments without materially departing from the novel teachings and advantages of the invention. Accordingly, these and all such modifications are intended to be included within the scope of this invention. The invention may be better defined by the following exemplary claims.

What is claimed is:

1. A system for managing computer environment data, comprising:
a management processor comprising a data store capable of storing and retrieving computer environment data; and
an intermediate processor comprising a data cache capable of storing a portion of the computer environment data.

2. The system as recited in claim 1 wherein the data cache cooperates with computing environment components to request data based on selected conditions and stores the requested data for future use by the computing environment.

3. The system as recited in claim 1 further comprising a data cache logic module having at least one instruction set and providing at least one instruction to the data cache to process the computer environment data.

4. The system as recited in claim 3 further comprising a data agent operating on the computing environment to request and manage computing environment data from cooperating computing environment components.

5. The system as recited in claim 4 further comprising the data store cooperating with the management processor to store the computing environment data.

6. The system as recited in claim 5 further comprising a data cache logic module operable on the data cache to provide the data cache instructions for requesting and storing the computing environment data.

7. The system as recited in claim 6 wherein the data cache is resident on the intermediate processor.

8. The system as recited in claim 7 wherein the data agent manages requests for the computing environment data for the computing environment.

9. The system as recited in claim 8 wherein the data agent sends a request for the computer environment data to the intermediate processor.

10. The system as recited in claim 9 wherein the intermediate processor cooperates with the data cache to determine if the requested computer environment data is resident in the data cache.

11. The system as recited in claim 10 wherein the data cache searches for the requested computing environment data according to at least one instruction from the data cache logic module.

12. The system as recited in claim 11 wherein the data cache retrieves the requested computing environment data if present in the data cache and returns the requested computing environment data to the data agent.

13. The system as recited in claim 12 wherein the data cache cooperates with the management processor and the data store to request a large data block of computing environment data to be transmitted from the management processor to the data cache for storage in the data cache.

14. The system as recited in claim 13 wherein the data cache determines if the large data block received from the management processor and the data store contain the requested computing environment data.

15. The system as recited in claim 14 wherein the data cache upon identifying that the requested computing environment data is present in the large data block received from the management processor returns the requested computing environment data to the data agent.

16. The system as recited in claim 15 wherein the system comprises computing components operable according to the intelligent platform management interface (IPMI) specification.

17. A method for managing computing environment data comprising:
receiving computing environment large data blocks from a first processor having a data storage unit by a data cache resident on a second processor;
storing the received large data blocks in the data cache;
receiving a request for computing environment data from one or more cooperating computing environment components; and
returning the by the data cache requested computing environment data stored in the data cache to the one or more computing environment components requesting the computing environment data.

18. The method as recited in claim 17 further comprising requesting the large blocks of computing environment data by the data cache from the first processor.

19. The method as recited in claim 18 further comprising storing a plurality of large blocks of data of computing environment data by a data store resident on the first processor.

20. The method as recited in claim 18 further comprising upon locating the requested data in the data cache, returning the requested data to the data agent.

21. The method as recited in claim 20 further comprising processing the requested data by one or more components of the computing environment.

22. The method as recited in claim 21 further comprising providing a computing application to process the requested computing environment data.

23. The method as recited in claim 18 further comprising processing the requested computing environment data by one or more components of the computing environment.

24. A computer readable medium having computer readable instructions to instruct a computer to perform a method comprising:
receiving computing environment large data blocks from a first processor having a data storage unit by a data cache resident on a second processor;
storing the received large data blocks in the data cache;
receiving a request for computing environment data from one or more cooperating computing environment components; and
returning the requested computing environment data stored in the data cache to the one or more computing environment components requesting the computing environment data.

25. A method managing computing environment data in an IPMI based environment comprising:
providing a data cache operable between a management processor, processor dependent hardware, block transfer hardware, and computing environment system, to retrieve and store data for use by the computing environment; and
an instruction set providing instructions to the data cache to process, retrieve, and store data.

26. The method as recited in claim 25 further comprising communicating a request for computing environment data from the operating system to other IPMI components.

27. The method as recited in claim 26 further comprising storing data in the data cache for use by the computing environment.

28. The method as recited in claim 27 further comprising satisfying the request for data by searching the data cache for the requested data.

29. The method as recited in claim 28 further comprising satisfying the request for data by searching the data cache for system event log (SEL) entries in accordance with a IPMI specification.

30. The method as recited in claim 25 further comprising transferring a large block of data of computing environment data from the management processor to the data cache for use by the computing environment.

31. The method as recited in claim 30 further comprising transferring a portion of the large block of data of computing environment data from the data cache to one or more cooperating computing environment components requesting computing environment data.
